(19) United States
(12) Patent Application Publication
(10) Pub. No.: US 2010/0095793 A1
(43) Pub. Date: Apr. 22, 2010

(54) STEERING DEVICE USING BALL SCREW

(75) Inventors: Yuji Tachikake, Tokyo (JP); Motoki Abe, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 12/517,111

(22) PCT Filed: Dec. 3, 2007
(86) PCT No.: PCT/JP2007/073312

§ 371 Date: Jun. 1, 2009

(30) Foreign Application Priority Data
Dec. 5, 2006 (JP) 2006-328487
Jun. 19, 2007 (JP) 2007-161829

(51) Int. Cl. F16H 25/22

(52) U.S. Cl. 74/424.81

(57) ABSTRACT

Provided is a steering device which can be reduced in size and weight and easily adapted even to a vehicle with a small engine room, such as a front-wheel-drive car. The steering device includes: a relay rod rotatably supported with respect to a gear casing and having a spiral ball rolling groove formed therein; an input shaft to which rotation of a steering shaft is transmitted; a rotation transmitting means for converting rotation of the input shaft into rotational movement of the relay rod and for allowing the relay rod to move in an axial direction thereof; a screw nut threadedly engaged with the ball rolling groove of the relay rod through an intermediation of a large number of balls and fixed to the gear casing, for allowing the relay rod to move in accordance with rotation of the relay rod in the axial direction thereof; a pair of tie rods for moving steerable wheels in accordance with axial movement of the relay rod; and a pair of spherical bearings for transmitting the axial movement of the relay rod to the tie rods without transmitting the rotational movement of the relay rod to the tie rods.

### TECHNICAL FIELD

The present invention relates to a steering device for operating steerable wheels in accordance with rotation of a steering shaft, and more particularly, to a steering device of a type in which rotational movement of a steering shaft is converted into axial movement of a relay rod with use of a ball screw.

### BACKGROUND ART

Conventionally, as steering devices for operating vehicle steerable wheels, there has been known one called a rack and pinion type.

In the rack and pinion type, while rack gears are formed on a relay rod coupled with knuckle arms of steerable wheels through an intermediation of tie rods, pinion gears meshing with the rack gears are provided at the leading end of a steering shaft to which rotation is imparted by a driver. Rotational movement of a steering shaft is directly converted into axial movement of the relay rod so that the direction of the steerable wheels is changed by pushing and retracting the knuckle arms with use of the tie rods (JP 2005-199776 A).

Meanwhile, known examples of the other types in which axial movement is imparted with respect to the relay rod without use of the rack gears include one in which a ball screw is used.

Specifically, while a spiral ball rolling groove is formed to the relay rod, a screw nut is threadedly engaged with the ball rolling groove through an intermediation of a large number of balls. The screw nut is rotated in accordance with the rotation amount of the steering shaft so that axial movement is imparted to the relay rod, whereby the direction of the steerable wheels is changed (JP 2004-284407 A).

Patent Document 1: JP 2005-199776 A

Patent Document 2: JP 2004-284407 A

### DISCLOSURE OF THE INVENTION

### Problem to be Solved by the Invention

However, in the steering device of the rack and pinion type, the rack gears are formed on a part of the relay rod. In this context, when the strength of the rack gears is taken into consideration, it is necessary that the shaft diameter of the relay rod be of a certain magnitude or more. Thus, in comparison with the proper mechanical strength of the relay rod, which is necessary for the operation of the steerable wheels, it is inevitable that the shaft diameter of the relay rod provided with the rack gears formed thereon is excessively large. Further, the rack gears are formed, and hence the relay rod cannot be formed as a hollow shaft. Thus, there has been a problem in that it is difficult to achieve weight reduction of the relay rod.

Further, in the steering device of the rack and pinion type, the surface resistance of the steerable wheels is directly offered to the rack shaft, and hence a larger force is required for moving the rack shaft in the axial direction. In this context, the pinion gears run idle when the pinion gears are pressed against the rack gears. Thus, in the steering device of the rack and pinion type, rack guides urged by retainer springs are provided behind the rack gears of the rack shaft, and the rack guides press the rack gears against the pinion gears with a predetermined pressure.

However, when the rack guides are held in press-contact with the rack shaft as described above, there has been a problem in that movement of the rack shaft becomes heavier due to frictional forces therebetween, and smooth movement of the rack shaft is hindered. Also in the case where an electric power steering device is constituted, large resistance is offered to the axial movement of the rack shaft. Thus, it is necessary for the electric motor to generate large rotational torque, which has led to problems in that the electric motor becomes larger and cost thereof increased. Further, the rack guides are required, and hence there has also been a problem in that the steering gear box itself for accommodating the rack gears and the pinion gears becomes larger.

Meanwhile, in the conventional steering device with use of the ball screw, the screw nut is rotated, whereby the relay rod is moved in the axial direction. Thus, it is necessary to mount the screw nut to the steering gear box through an intermediation of a rotational bearing, and hence the steering gear box inevitably becomes larger and heavier by that much.

Further, an axial load is applied to the screw nut from the relay rod, and hence the bearing for supporting the rotation of the screw nut has to be capable of sufficiently bearing both a radial load and a thrust load. Thus, the rotational bearing inevitably becomes larger, and by extension, the steering gear box inevitably becomes larger and heavier.

The above-mentioned increase in size of the steering gear box directly leads to an increase in vehicle weight, and a larger operating force is required for the operation of the steering device when the vehicle weight is increased. In recent years, power steering devices have prevailed as devices for reducing the operating force of the steering device. However, the vehicle weight is increased even in the case where the power steering device is mounted, whereby energy efficiency of an engine is deteriorated.

### Means for Solving the Problem

The present invention has been made in view of the above-mentioned problems. It is an object of the present invention to provide a steering device which can be further reduced in size and weight and easily adapted even to a vehicle with a small engine room, such as a front-wheel-drive car.

Further, it is another object of the present invention to provide a steering device which can be steered, in the case of being used in a lightweight vehicle such as a small car, with a small operating force without use of the power steering device and contributes to energy saving.

That is, the present invention includes:

a gear casing;

a relay rod passing through the gear casing, rotatably supported with respect to the gear casing, and having a spiral ball rolling groove formed in an outer peripheral surface thereof;

an input shaft to which rotation of a steering shaft is transmitted;

a rotation transmitting means for converting rotation of the input shaft into rotational movement of the relay rod and for allowing the relay rod to move in an axial direction thereof;

a screw nut threadedly engaged with the ball rolling groove of the relay rod through an intermediation of a large number of balls and fixed to the gear casing, for allowing the relay rod to move in accordance with rotation of the relay rod in the axial direction thereof;

a pair of tie rods coupled with both axial ends of the relay rod, for moving steerable wheels in accordance with axial movement of the relay rod; and

a pair of spherical bearings provided between the relay rod and the tie rods, for transmitting the axial movement of the relay rod to the tie rods without transmitting the rotational movement of the relay rod to the tie rods.

In the steering device of the present invention as described above, when a driver operates the steering wheel and the rotation of the steering shaft is transmitted to the input shaft, the rotation of the input shaft is transmitted to the relay rod through an intermediation of the rotation transmitting means. The screw nut threadedly engaged with the relay rod is fixed to the gear casing. Thus, when the relay rod is rotated, the relay rod consequently moves in the axial direction in accordance with the rotational direction and the rotation amount thereof. The axial movement of the relay rod is transmitted to the steerable wheels via the tie rods. Further, the relay rod and the tie rods are coupled with each other through an intermediation of the spherical bearings, and hence the rotation of the relay rod is absorbed by the spherical bearings, and hence not transmitted to the tie rods.

In the present invention, while the ball rolling groove is formed to the relay rod, in comparison with the case of forming the rack gears, strength of the relay rod can be sufficiently maintained even when the shaft diameter thereof is reduced. That is, the relay rod has a characteristic of being easily reduced in size and weight. Further, even when the ball rolling groove is formed, the relay rod itself can be formed as a hollow shaft. Also in this regard, it is possible to attain weight reduction of the relay rod, and by extension, weight reduction of the whole steering device.

Further, the rotation of the input shaft is transmitted not to the screw nut but to the relay rod through an intermediation of the rotation transmitting means, the rotation transmitting means allowing the relay rod to move in the axial direction. Thus, an axial load applied to the relay rod is not applied to the rotation transmitting means, and hence the structure of the rotation transmitting means can be simplified. Accordingly, also in this regard, the steering device of the present invention can be reduced in size and weight.

As described above, the steering device of the present invention can be reduced in size and weight in comparison with conventional ones, and hence is optimum for small cars. Further, the steering device itself is reduced in size and weight, and hence the load applied to the steering wheel is reduced. As a result, burden on a driver during steering is reduced, whereby the power steering device is omitted so as to increase the energy efficiency.

### BRIEF DESCRIPTION OF THE DRAWINGS

FIG. 1 is a schematic view of an example of a steering device.

FIG. 2 is a perspective view illustrating a mechanism in the inside of a gear casing of a steering device to which the present invention is applied.

FIG. 3 is an exploded perspective view illustrating an assembly state of a spline nut and an input shaft with respect to the gear casing.

FIG. 4 is an exploded perspective view illustrating a retention mechanism according to a first embodiment of the present invention.

FIG. 5 is an enlarged view illustrating the retention mechanism corresponding to a straightforward advance position of steerable wheels.

FIG. 6 is an enlarged view illustrating the retention mechanism when the steerable wheels are operated.

FIG. 7 is an enlarged view illustrating the retention mechanism when an engagement state of the retention mechanism and the relay rod is cancelled.

FIG. 8 is an enlarged view illustrating a retention mechanism according to a second embodiment of the present invention.

FIG. 9 is an exploded perspective view of the retention mechanism illustrated in FIG. 8.

FIG. 10 is an enlarged view illustrating the retention mechanism according to the second embodiment when the steerable wheels are operated.

FIG. 11 is an enlarged view illustrating the retention mechanism according to the second embodiment when an engagement state of the retention mechanism and the relay rod is cancelled.

FIG. 12 is an enlarged view illustrating a retention mechanism according to a third embodiment of the present invention.

FIG. 13 is an exploded perspective view of the retention mechanism illustrated in FIG. 12.

FIG. 14 is an enlarged view illustrating the retention mechanism according to the third embodiment when the steering wheels are operated.

### BEST MODE FOR CARRYING OUT THE INVENTION

In the following, a steering device of the present invention is described in detail with reference to the accompanying drawings.

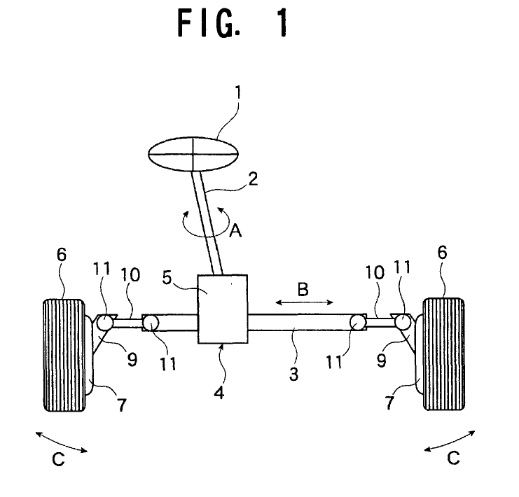

FIG. 1 is a schematic view of an example of a steering device. This steering device has a steering shaft 2 to which rotation of a steering wheel 1 is transmitted, a relay rod 3 moving in accordance with rotation of the steering shaft 2 in an axial direction thereof, and a steering gear box 4 for converting rotation of the steering shaft 2 into axial movement of the relay rod 3, the relay rod 3 passing through a gear casing 5 of the steering gear box 4. Hubs 7 for supporting right and left steerable wheels 6 are provided with knuckle arms 9, and the ends of the relay rod 3 are respectively coupled with the right and left knuckle arms 9 through an intermediation of tie rods 10. The coupling between the knuckle arms 9 and the tie rods 10 and the coupling between the tie rods 10 and the relay rod 3 are effected through an intermediation of spherical bearings 11.

When the steering wheel 1 is turned to rotate the steering shaft 2 in one of the directions as indicated by the arrow line A, the relay rod 3 moves in the axial direction (indicated by arrow line B) in accordance with the rotational direction thereof, and the tie rods 10 push and draw the knuckle arms 9, with the result that the right and left steerable wheels 6 swing as indicated by the arrow lines C so as to be changed in their direction.

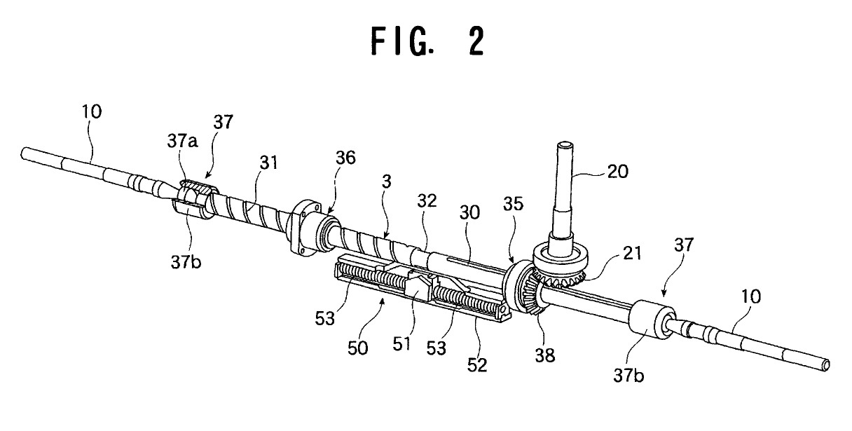

FIG. 2 illustrates an example of the steering gear box 4 to which the present invention is applied, specifically, is a perspective view illustrating a state in which the gear casing 5 is omitted. The relay rod 3 passes through the gear casing of the steering gear box 4, and has a spline groove 30 formed in the surface thereof along an axial direction of the relay rod 3 and has a spiral thread groove 31 formed also therein. The spline groove 30 and the thread groove 31 are formed without being superimposed on each other in the outer peripheral surface of the relay rod 3, and an annular engagement groove 32 is formed between the spline groove 30 and the thread groove 31.

A spline nut 35 is engaged with the spline groove 30 through an intermediation of a large number of balls. The spline nut 35 is movable with respect to the relay rod 3 in the axial direction thereof, and is capable of transmitting rotational torque between the spline nut 35 and the relay rod 3. Further, the spline nut 35 is rotatably supported with respect to the gear casing so as to allow the relay rod 3 to be rotated together with the spline nut 35 when the spline nut 35 is rotated with respect to the gear casing.

Meanwhile, a screw nut 36 is threadedly engaged with the thread groove 31 through an intermediation of a large number of balls, and a ball screw is constituted by the relay rod 3 and the screw nut 36. The screw nut 36 is fixed to the gear casing so as to allow the relay rod 3 to move, when the relay rod 3 is rotated, in the axial direction with respect to the screw nut 36 in accordance with the rotation amount thereof.

That is, when rotation is imparted to the spline nut 35 so as to move the relay rod 3 together with the spline nut 35, through the working of the screw nut 36, the relay rod 3 moves in the axial direction in accordance with the rotational direction and the rotation amount thereof. In this case, the spline nut 35 consequently rotates the relay rod 3 while allowing the relay rod 3 to move in the axial direction.

Further, the tie rods 10 are respectively coupled with both the ends of the relay rod 3 through an intermediation of spherical bearings 37. In FIG. 2, one of the spherical bearings 37 provided at the left end of the relay rod 3 is illustrated in a partially notched manner. Each of the spherical bearing 37 is constituted by a ball part 37a provided at one end of each of the tie rods 10 and a holder 37b fixed to each of the end parts of the relay rod 3 and wrapping and holding the ball part 37a of each of the tie rods 10, the tie rods 10 being rotatably and rockably coupled with respect to the relay rod 3. The rocking center of each of the tie rods 10 corresponds to the axial center of the relay rod 3. Further, while not shown in FIG. 2, as described above, the end parts of the tie rods 10, which are opposite to the ball part 37a, are coupled with the knuckle arms 9. Thus, when the relay rod 3 moves in the axial direction, the knuckle arms 9 are pushed and drawn through an intermediation of the tie rods 10 so that the direction of the steerable wheels 6 can be changed in accordance with the axial movement amount of the relay rod 3. The rotation of the relay rod 3 is generated in accordance with the axial movement thereof. In this context, the one ends of the tie rods 10 are rotatably coupled with respect to the relay rod 3 through an intermediation of the spherical bearings 37, and the other ends thereof are coupled with the knuckle arms 9. Therefore, even when the relay rod 3 is rotated, the spherical bearings 37 absorb the rotation thereof, and hence rotation of tie rods 10 is not generated.

The rotation of the steering shaft 2 is transmitted to the input shaft 20 illustrated in FIG. 2 so that the input shaft 20 rotates the spline nut 35 in accordance with the rotation of the steering shaft 2. A driving bevel gear 21 is fixed at the leading end of the input shaft 20, and the bevel gear 21 meshes with a driven bevel gear 38 provided to the spline nut 35. With this, when a driver turns the steering wheel 1, the turn is transmitted to the spline nut 35 so that the relay rod 3 is rotated. That is, the bevel gears 21 and 38 and the spline nut 35 correspond to a rotation transmitting means of the present invention.

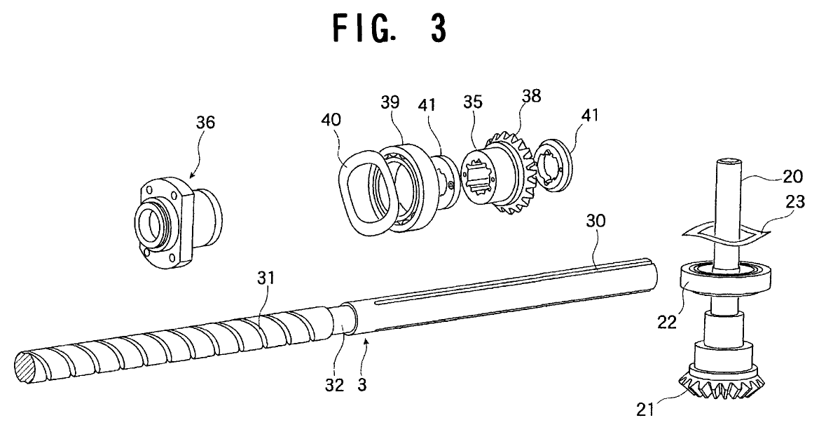

FIG. 3 is an exploded perspective view illustrating an assembly state of the spline nut 35 and the input shaft 20 with respect to the gear casing. A rotational bearing 39 is fitted to the outer peripheral surface of the spline nut 35, and the spline nut 35 is mounted to the gear casing 5 through an intermediation of the rotational bearing 39. The relay rod 3 is movable in the axial direction with respect to the spline nut 35, and the spline nut 35 does not bear the axial load of the relay rod 3. Thus, it is unnecessary for the rotational bearing 39 to bear the thrust load along the axial direction of the relay rod 3, and it is sufficient to bear only the radial load. With this, it is possible to reduce the rotational bearing 39 in diameter and cost. Note that, an end cap for forming an endless circulation path of the balls in the spline nut 35 is denoted by reference numeral 41 in FIG. 3, the end cap being used while being fixed to both the axial end surfaces of the spline nut 35.

Meanwhile, the input shaft 20 provided with the bevel gear 21 is also fixed to the gear casing 5 through an intermediation of a rotational bearing 22.

It is unnecessary for the spline nut 35 to bear the thrust load, and hence it is unnecessary to strictly fix the spline nut 35 with respect to the gear casing 5 in the axial direction of the relay rod 3. Thus, a ring-like elastic member 40 is provided between the rotational bearing 39 and the gear casing 5, and presses the rotational bearing 39 and the spline nut 35 from behind in the direction in which the bevel gears 21 and 38 mesh with each other. Further, an elastic member 23 is similarly provided between the rotational bearing 22 for supporting the rotation of the input shaft and the gear casing 5, and the bevel gear 21 is urged in the direction of meshing with the bevel gear 38. With this, backlashes between the bevel gear 21 and the bevel gear 38 are eliminated, whereby response of the axial movement of the relay rod 3 with respect to the operation of the steering wheel 1 is enhanced.

In this steering device, there is provided a retention mechanism 50 for enhancing straightforward stability of a vehicle, imparting a moderate steering feel to a driver, and for restoring the relay rod 3 to a predetermined position with respect to the gear casing 5. The predetermined position corresponds to the straightforward advance position of the steerable wheels 6. As illustrated in FIG. 2, the retention mechanism 50 is accommodated in the gear casing 5 while being engaged with the relay rod 3, and is fixed with respect to the gear casing 5.

FIG. 3 is an exploded perspective view specifically illustrating the retention mechanism 50. The retention mechanism 50 includes a restriction block 51 fitted to the engagement groove 32 of the relay rod 3, a guide plate 52 for guiding the restriction block 51 along the axial direction of the relay rod 3, and a pair of piston members 54 urged by coil springs 53 so as to press the restriction block 51 from the opposite directions. On the surface of the guide plate 52, a linear protrusion is formed along the axial direction of the relay rod 3, and the restriction block 51 is movable on the surface of the guide plate 52 while being fitted to the linear protrusion. The piston members 54 are urged by the coil blocks 53, with the leading end parts thereof being held in contact with the side surfaces of the restriction block 51. Endplates 55 for locking the coil springs 53 are provided upright at both longitudinal ends of the guide plate 52.

Further, in the retention mechanism 50, the restriction block 51 advances and retracts with respect to the relay rod 3 in accordance with the position of the restriction block 51 on the guide plate 52 so as to maintain or cancel a fitting state of the restriction block 51 with respect to the engagement groove 32 of the relay rod 3.

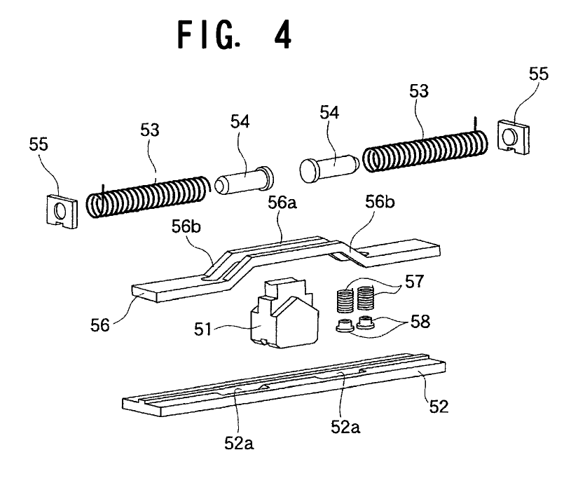

In order to realize the operation as described above of the restriction block 51, a regulation plate 56 is provided on the guide plate 52 while straddling the pair of endplates 55. The restriction block 51 is fitted to the engagement groove 32 of the relay rod 3 through an intermediation of a slit provided to the regulation plate 56. A part of the regulation plate 56, at which the slit is formed, protrudes in a trapezoidal shape toward the relay rod 3, and includes a central linear region 56a and tapered regions 56b positioned on both sides thereof. Coil springs 57 are accommodated in the inside of the restriction block 51, and urge the restriction block 51 in the direction of being separated from the guide plate 52, that is, toward the relay rod 3. Accordingly, the restriction block 51 moves on the guide plate 52 while being constantly held in contact with the regulation plate 56 so as to be pressed down toward the guide plate 52 at the time of departing from the linear region 56a and entering the tapered regions 56b. Further, in order to enable the restriction block 51 to advance and retract as described above, recess parts 52a are formed in the surface of the guide plate 52 correspondingly to the tapered regions 56b of the regulation plate 56. Note that, sliding pieces interposed between the coil springs 57 and the linear protrusion of the guide plate 52 are denoted by reference numeral 58 in FIG. 4.

With this structure, in a state in which no external force acts on the restriction block 51, the restriction block 51 is retained at the center of the guide plate 52 through the working of the pair of piston members 54. In this case, the restriction block 51 is fitted to the engagement groove 32 of the relay rod 3. Further, when the restriction block 51 is moved on the guide plate 52 along the axial direction of the relay rod 3 against an urging force of any one of the coil springs 53, the restriction block 51 shifts from the linear region 56a to the tapered regions 56b of the regulation plate 56. In accordance therewith, the restriction block 51 is gradually pressed down to the guide plate 52, with the result that the fitting state of the restriction block 51 is cancelled with respect to the engagement groove 32 of the relay rod 3.

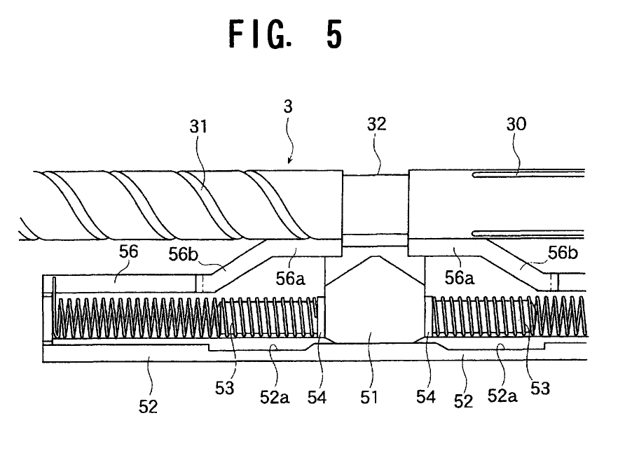

FIGS. 5 to 7 illustrate the movement of the retention mechanism 50 with respect to the axial position of the relay rod 3. FIG. 5 illustrates a state in which no external force acts on the restriction block 51. In this state, the urging forces of the coil springs 53 on both the sides of the restriction block 51 are balanced, and the restriction block 51 is retained at the central position of the guide plate 52 and is fitted with respect to the engagement groove 32 of the relay rod 3. This state corresponds to the straightforward advance position of the steerable wheels 6.

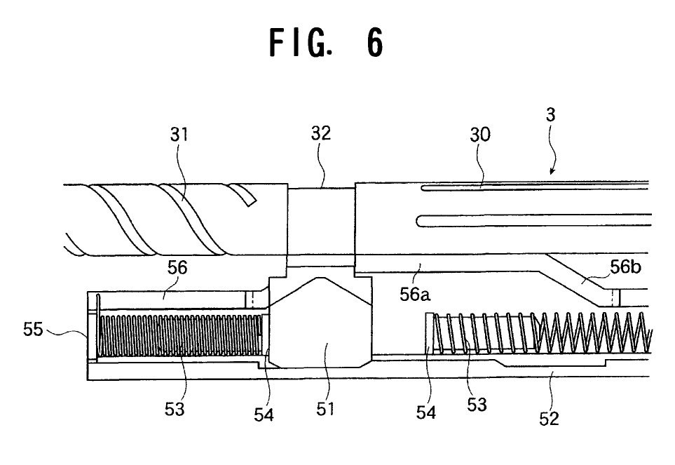

In this state, when a driver turns the steering wheel 1 so as to perform a steering operation, the relay rod 3 consequently moves in the axial direction while being rotated as described above. Thus, as illustrated in FIG. 6, the restriction block 51 is forcibly moved on the guide plate 52 while being fitted to the engagement groove 32 of the relay rod 3, and only one of the coil springs 53, which urges the restriction block 51, is compressed. As the compression amount is increased, the one of the coil springs 53 is to press and restore the restriction block 51 to the central position with a larger urging force, and the urging force acts also on the relay rod 3 with which the restriction block 51 is fitted. Accordingly, an axial force for retaining the steerable wheels 6 to the straightforward advance position consequently acts on the relay rod 3. The axial force is converted into rotational torque of the relay rod 3 and the spline nut 35 by means of the screw nut 36, and is transmitted to the steering wheel 1 through an intermediation of the input shaft 20 and the steering shaft 2.

That is, a force for constantly retaining the steerable wheels 6 to the straightforward advance position consequently acts in the steering device, whereby straightforward stability of a vehicle is enhanced. Further, when the driver releases the steering wheel 1, the steering wheel 1 is automatically restored to the central position corresponding to the straightforward advance of a vehicle. Thus, it is also possible to reduce burden with respect to the drive operation. Further, when a spring constant of the coil springs 53 urging the restriction block 51 is appropriately selected, it is possible to impart a moderate resisting feel with respect to the operation of the steering wheel 1, thereby possible to freely change an operational feel of the steering device.

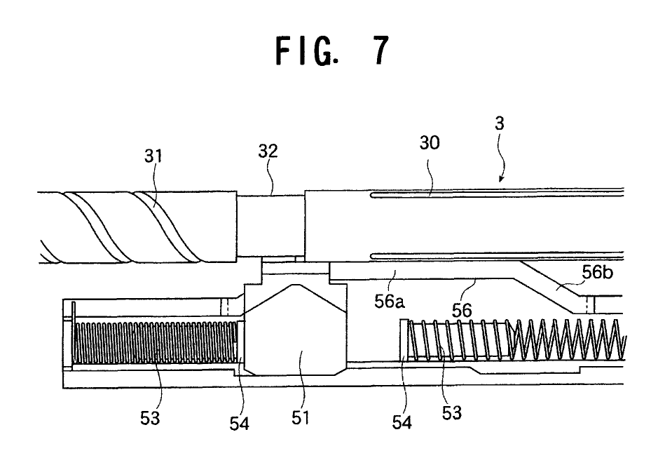

Meanwhile, in the case of greatly changing the direction of the steerable wheels 6, the restriction block 51 is disengaged from the engagement groove 32 of the relay rod 3 so that the urging forces of the coil springs 53 are not transmitted from the restriction block 51 to the relay rod 3. When the relay rod 3 is further moved in the axial direction in the state illustrated in FIG. 6, the restriction block 51 shifts from the linear region 56a to the tapered regions 56b of the regulation plate 56 so as to be pressed down toward the guide plate 52 by means of the regulation plate 56. Consequently, as illustrated in FIG. 7, an engagement state of the restriction block 51 and the engagement groove 32 of the relay rod 3 is cancelled. When the engagement state of the restriction block 51 and the relay rod 3 is cancelled in this manner, the relay rod 3 is movable in the axial direction without receiving the urging forces of the coil springs 53, which enables a driver to easily operate the steering wheel 1.

The restriction block 51 pressed downward by means of the regulation plate 56 is stuck into the recess parts 52a of the guide plate 52. Unless the restriction block 51 is fitted again to the engagement groove 52 of the relay rod 3, the restriction block 51 cannot be disengaged from the recess parts 52a so as to move on the guide plate 52. Accordingly, when a driver turns the steering wheel 1 in the opposite direction toward the original central position in the state illustrated in FIG. 7, the engagement groove 32 of the relay rod 3 and the restriction block 51 are fitted again to each other as illustrated in FIG. 6. After that, the steering wheel 1 can be restored to the central position by utilizing the urging forces of the coil springs 53.

That is, with use of the retention mechanism 50 structured as described above, it is possible to impart a moderate steering feel with respect to the operation of the steering wheel 1 only with the mechanical structure without electrical control. Further, in the case where the operation amount of the steering wheel 1 is large, it is possible to lighten the steering of the steering wheel 1, thereby possible to provide a smaller and lower-cost steering device with excellent steering feel.

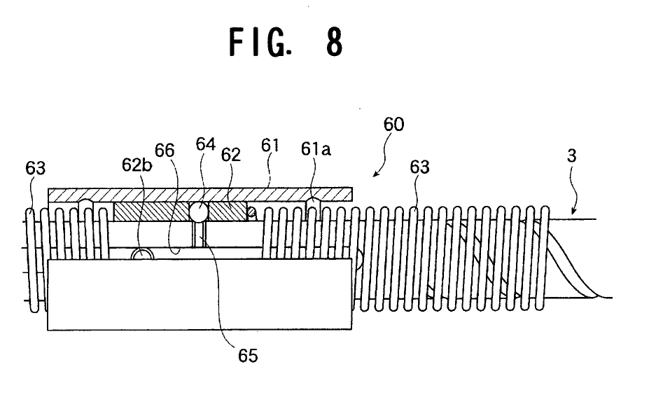

FIG. 8 illustrates another example of the retention mechanism. While the retention mechanism 50 illustrated in FIGS. 2 and 4 is provided adjacent to the relay rod 3, a retention mechanism 60 illustrated in FIG. 8 is provided while surrounding the relay rod 3 so as to be coaxial therewith.

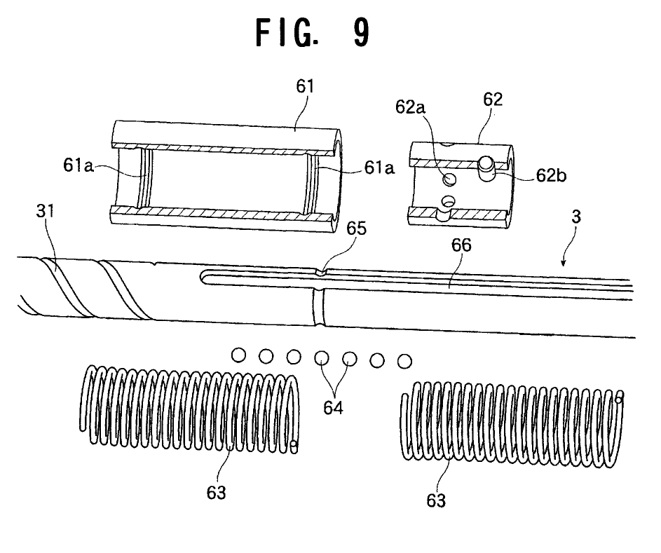

FIG. 9 is an exploded perspective view of the retention mechanism 60. The retention mechanism 60 is constituted by a fixation outer cylinder 61 loosely fitted around the relay rod 3, a restriction sleeve 62 interposed between the fixation outer cylinder 61 and the relay rod 3, a pair of coil springs 63 provided coaxially with the relay rod 3, for urging the restriction sleeve 62 while being opposite to each other, and multiple balls 64 for establishing an engagement state of the restriction sleeve 62 and the relay rod 3. Note that, in FIG. 9, the fixation outer cylinder 61 and the restriction sleeve 62 are illustrated in a partially notched manner.

The fixation outer cylinder 61 is retained in the gear casing 5, and the relay rod 3 passes through the fixation outer cylinder 61 so as to be freely movable in the axial direction. Further, the restriction sleeve 62 has outer diameter smaller than inner diameter of the fixation outer cylinder 61 while having inner diameter larger than outer diameter of the relay rod 3, thereby being capable of freely moving in the axial direction between the fixation outer cylinder 61 and the relay rod 3. In addition, accommodating holes 62a for the balls 64 are arranged in a circumferential direction of the restriction sleeve 62, the restriction sleeve 62 being interposed between the fixation outer cylinder 61 and the relay rod 3 while retaining the balls 64 in the accommodating holes 62a. The balls 64 have diameter larger than a gap between the fixation outer cylinder 61 and the relay rod 3. However, an engagement groove 65 is formed along the circumferential direction of the relay rod 3, and hence, in the state in which the balls 64 retained in the accommodating holes 62a of the restriction sleeve 62 are fitted into the engagement groove 65, it is possible to cover the restriction sleeve 62 with the fixation outer cylinder 61 without involving interference of the balls 64. In this context, when the restriction sleeve is covered with the fixation outer cylinder, the balls cannot be disengaged from the engagement groove of the relay rod, whereby the engagement state of the restriction sleeve and the relay rod is maintained.

Each of the coil springs 63 has one end held in contact with the restriction sleeve 62 and the other end locked by the gear casing 5, and works so as to urge the restriction sleeve 62 in the opposite direction. Further, a position at which urging forces of the coil springs 63 are balanced so that the restriction sleeve 62 is stopped is a position at which the engagement groove 65 of the relay rod 3 corresponds to the axial center of the fixation outer cylinder 61. Accordingly, in the state in which the steering wheel 1 is not operated and no external force is caused to act on the relay rod 3, the engagement groove 65 of the relay rod 3 is consequently positioned at the longitudinal center of the fixation outer cylinder 61.

Further, in the inner peripheral surface of the fixation outer cylinder 61, retention grooves 61a are formed along the circumferential direction at the positions slightly displaced from the opening ends thereof. In accordance with the movement of the relay rod 3 with respect to the fixation outer cylinder 61, when the balls 64 retained by the restriction sleeve 62 reach the positions at which the retention grooves 61a are formed, the balls 64 are disengaged from the engagement groove 65 of the relay rod 3 so as to be fitted into the retention grooves 61a of the fixation outer cylinder 61. With this, the engagement state of the relay rod 3 and the restriction sleeve 62 is cancelled.

Further, a key groove 66 is formed in the relay rod 3 along the axial direction thereof, and a leading end of a pin 62b passing through the restriction sleeve 62 is fitted into the key groove 66. With this, when the relay rod 3 is rotated, the restriction sleeve 62 is also rotated in the inside of the fixation outer cylinder 61 together with the relay rod 3.

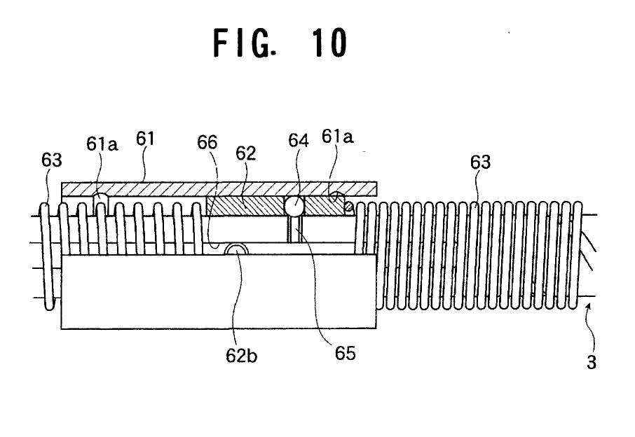

FIG. 8 illustrates a state in which the pair of coil springs 63 evenly exert urging forces and the steerable wheels 6 are retained at the straightforward advance position. In this case, the balls retained in the accommodating holes of the restriction sleeve are fitted into the engagement groove of the relay rod, the balls being positioned at the longitudinal center of the fixation sleeve. When a driver turns the steering wheel 1 in this state so as to perform a steering operation, the relay rod 3 consequently moves in the axial direction while being rotated as described above. In this case, the balls 64 are fitted to the engagement groove 65 of the relay rod 3, and the engagement state of the restriction sleeve 62 and the relay rod 3 is maintained. Thus, as illustrated in FIG. 10, the restriction sleeve 62 is forcibly moved in the axial direction in the inside of the fixation outer cylinder 61 together with the relay rod 3, and hence only one of the coil springs 63, which urges the restriction sleeve 62, is compressed. With this, the urging force for pressing and restoring the restriction sleeve 62 to the central position is applied thereto from the coil springs 63, and acts also on the relay rod 3 through an intermediation of the balls 64. Accordingly, an axial force for retaining the steerable wheels 6 to the straightforward advance position consequently acts on the relay rod 3. The axial force is converted into rotational torque of the relay rod 3 and the spline nut 35 by means of the screw nut 36, and is transmitted to the steering wheel 1 through an intermediation of the input shaft 20 and the steering shaft 2.

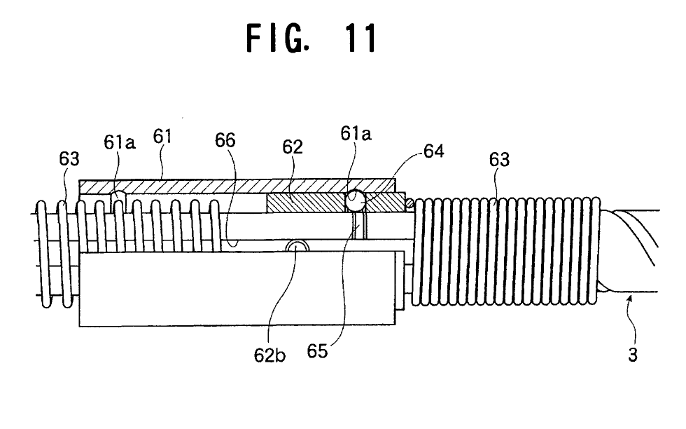

Meanwhile, in the case of greatly changing the direction of the steerable wheels 6, the balls 64 are disengaged from the engagement groove 65 of the relay rod 3 so that the urging forces of the coil springs 63 are not transmitted from the restriction sleeve 62 to the relay rod 3. When the relay rod 3 is further moved in the axial direction in the state illustrated in FIG. 10, the balls 64 have reached the positions at which the retention grooves 61a of the fixation outer cylinder 61 are formed as illustrated in FIG. 11 so as to be capable of being disengaged from the engagement groove 65 of the relay rod. Thus, the balls 64 are disengaged from the engagement groove 65 of the relay rod 3 and fitted into the retention grooves 61a of the fixation outer cylinder 61, whereby the engagement state of the relay rod 3 and the restriction sleeve 62 is cancelled. When the engagement state of the restriction sleeve 62 and the relay rod 3 is cancelled in this manner, the relay rod 3 is movable in the axial direction without receiving the urging forces of the coil springs 63, which enables a driver to easily operate the steering wheel 1.

Further, when the steering wheel 1 is turned by a driver in the opposite direction toward the original central position and restored to the position at which the engagement groove 65 of the relay rod 3 is superimposed on the retention grooves 61a, the balls 64 are fitted into the engagement groove 65 of the relay rod 3 again and disengaged from the retention grooves 61a of the fixation outer cylinder 61, and the restriction sleeve 62 is consequently engaged with the relay rod 3. With this, thereafter, the steering wheel 1 can be restored to the central position by utilizing the urging forces of the coil springs 63.

That is, the retention mechanism 60 illustrated in FIG. 8 also exerts the same function as that of the retention mechanism 50 illustrated in FIG. 2. Note that, the retention mechanism 60 is provided coaxially with the relay rod 3, and hence it is possible to save the installation space in the gear casing 5, thereby possible to achieve further downsizing and weight-reduction of the steering device as a whole.

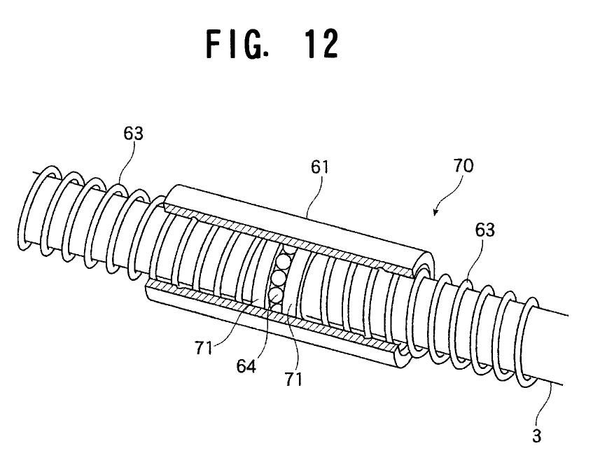

FIG. 12 illustrates a third embodiment of the retention mechanism.

A retention mechanism 70 according to the third embodiment is provided coaxially with the relay rod 3 while surrounding the same similarly to the retention mechanism 60 according to the second embodiment illustrated in FIG. 8. In the retention mechanism 60 according to the second embodiment, the large number of balls 64 are arranged with respect to the restriction sleeve 62 rotated together with the relay rod 3 so that the pair of coil springs 63 butt against the restriction sleeve 62. However, in the third embodiment, while the restriction sleeve 6 is omitted, a pair of bearing rings 71 rotatable with respect to the relay rod 3 are provided between the balls 64 and the coil springs 63 so that the coil springs 63 are held in press-contact with respect to the bearing rings 71.

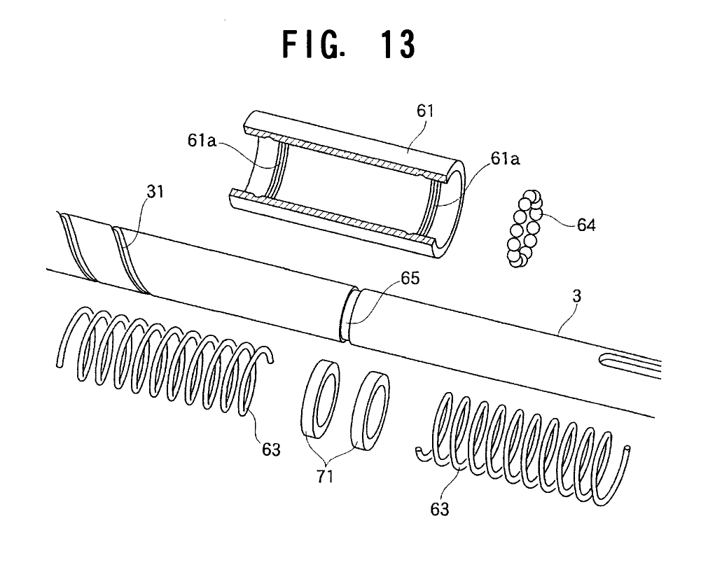

FIG. 13 is an exploded perspective view of the retention mechanism 70. The retention mechanism 70 is constituted by the multiple balls 64 arranged along the circumferential direction of the relay rod 3 and serving as the restriction member, the annular engagement groove 65 formed along the peripheral direction of the relay rod 3 so as to engage the balls 64 therewith, the fixation outer cylinder 61 fixed to the gear casing, for sandwiching the balls 64 between the fixation outer cylinder 61 and the relay rod 3, the pair of coil springs 63 for urging the balls 64 from both sides thereof in the axial direction of the relay rod 3 to the opposite directions, and the pair of bearing rings 71 interposed between the coil springs 63 and the balls 64. Note that, the structure of the fixation outer cylinder 61, the balls 64, the coil springs 63, and the engagement groove 65 is the same as that in the third embodiment described with reference to FIGS. 8 to 11. Further, in FIG. 13, the fixation outer cylinder 61 is illustrated in a partially notched manner.

Also in the third embodiment, the balls 64 have diameter larger than a gap between the fixation outer cylinder 61 and the relay rod 3. In the state in which the balls 64 are fitted into the engagement groove 65 of the relay rod 3, it is possible to cover the balls 64 with the fixation outer cylinder 61 without involving interference of the balls 64. In this context, when the balls 64 arranged in the engagement groove 65 are covered by the fixation outer cylinder 61, the balls 64 cannot be disengaged from the engagement groove 65 of the relay rod 3, whereby the balls 64 are engaged with the relay rod 3 in the axial direction of the relay rod 3.

Further, the bearing rings 71 are provided on both the sides of the balls 64 arranged in the engagement groove 65 of the relay rod 3, and the coil springs 63 operate so as to urge the balls 64 in the opposite directions through an intermediation of the bearing rings 71. The position at which the urging forces of the coil springs 63 are balanced is the position at which the engagement groove 65 of the relay rod 3 corresponds to the axial center of the fixation outer cylinder 61. Accordingly, in the state in which the steering wheel 1 is not operated and no external force is caused to act on the relay rod 3, as illustrated in FIG. 12, the engagement groove 65 of the relay rod 3 is consequently positioned at the longitudinal center of the fixation outer cylinder 61.

Further, similarly to the second embodiment, in the inner peripheral surface of the fixation outer cylinder 61, the pair of retention grooves 61a are formed at the positions slightly displaced from the opening ends thereof. Thus, when the relay rod 3 moves in the axial direction in accordance with the operation of the steering wheel 1 and the balls 64 fitted into the engagement groove 65 of the relay rod 3 reach the positions at which the retention grooves 61a are formed, the balls 64 are disengaged from the engagement groove 65 of the relay rod 3 so as to be fitted into the retention grooves 61a of the fixation outer cylinder 61. With this, the engagement state of the relay rod 3 and the restriction sleeve 62 is cancelled.

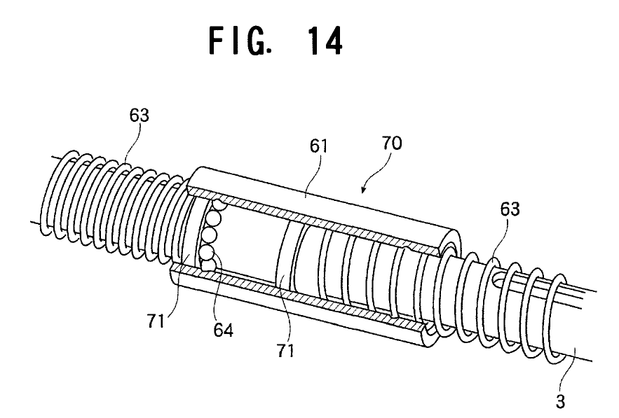

FIG. 12 illustrates a state in which the pair of coil springs 63 evenly exert urging forces and the steerable wheels 6 are retained at the straightforward advance position. In this case, the balls 64 are fitted into the engagement groove 65 of the relay rod 3, the balls 64 being positioned at the longitudinal center of the fixation sleeve 61. When a driver turns the steering wheel 1 in this state so as to perform a steering operation, the relay rod 3 moves in the axial direction while being rotated as described above. In this case, the balls 64 are fitted to the engagement groove 65 of the relay rod 3. As illustrated in FIG. 14, the balls 64 are forcibly moved in the axial direction in the inside of the fixation outer cylinder 61 together with the relay rod 3, and hence only one of the coil springs 63, which urges the balls 64 through an intermediation of corresponding one of the bearing rings 71, is compressed. With this, the urging force for pressing and restoring the balls 64 to the central position of the fixation sleeve 61 is applied thereto from the coil springs 63, and acts also on the relay rod 3 through an intermediation of the balls 64. Finally, as a force for retaining the steerable wheels 6 to the straightforward advance position, the urging force is transmitted to the steering wheel 1.

Meanwhile, in the case of greatly changing the direction of the steerable wheels 6, the relay rod 3 and the balls 64 are separated from each other at the time the balls 64 reach the retention grooves 61a of the fixation outer cylinder 61, whereby the urging forces of the coil springs 63 do not act on the relay rod 3. FIG. 14 illustrates a state in which the balls have reached one of the retention grooves 61a of the fixation outer cylinder 61. Even when the relay rod 3 is further moved in the axial direction by operating the steering wheel 1 in this state, the urging forces of the coil springs 63 do not act on the relay rod 3. Therefore, the relay rod is easily movable in the axial direction, which enables a driver to operate the steering wheel 1 with a small steering force.

Further, when the steering wheel 1 is turned by a driver in the opposite direction toward the original central position and restored to the position at which the engagement groove 65 of the relay rod 3 is superimposed on the retention grooves 61a of the fixation outer cylinder 61, the balls 64 are fitted into the engagement groove 65 of the relay rod 3 again and disengaged from the retention grooves 61a of the fixation outer cylinder 61, and the balls 64 are consequently engaged with the relay rod 3. With this, thereafter, the steering wheel 1 can be restored to the central position by utilizing the urging forces of the coil springs 63.

In the second embodiment described above, the pair of coil springs 63 are held in direct contact with respect to the restriction sleeve 62 rotated together with the relay rod 3. Thus, in the case where the urging forces of the coil springs 63 are large, there is a risk that the frictional forces between the coil springs 63 and the restriction sleeve 62 becomes larger so that the rotation of the relay rod 3, that is, the operation of the steering wheel 1 becomes less smooth. However, in the third embodiment, the bearing rings 71 of low friction are provided on both the sides of the balls 64 arranged in the engagement groove 65 in the relay rod 3, and the coil springs 63 are held in contact with respect to the bearing rings 71. The bearing rings 71 are freely rotatable with respect to the relay rod 3 and the balls 64, and the balls 64 held in contact with the bearing rings 71 are also freely movable with respect to the circumferential direction of the relay rod 3. Therefore, the rotation of the relay rod 3 does not prevented by the urging force of the coil springs 63, whereby the steering wheel 1 can be smoothly operated in comparison with the second embodiment.

1. A steering device, comprising:
a gear casing;
a relay rod, which passes through the gear casing, is rotatably supported with respect to the gear casing, and has a spiral ball rolling groove formed in an outer peripheral surface thereof;
an input shaft to which rotation of a steering shaft is transmitted;
a rotation transmitting means for converting rotation of the input shaft into rotational movement of the relay rod;
a screw nut threadedly engaged with the ball rolling groove of the relay rod through an intermediation of a large number of balls and fixed to the gear casing, for allowing the relay rod to move in accordance with rotation of the relay rod in an axial direction thereof;
a pair of tie rods coupled with both axial ends of the relay rod, for moving steerable wheels in accordance with axial movement of the relay rod; and
a pair of spherical bearings provided between the relay rod and the tie rods, for transmitting the axial movement of the relay rod to the tie rods without transmitting the rotational movement of the relay rod to the tie rods.

2. The steering device according to claim 1, wherein the rotation transmitting means comprises:
a spline groove formed in the outer peripheral surface of the relay rod along the axial direction thereof;
a spline nut which is fitted to the spline groove of the relay rod through an intermediation of a large number of balls, rotatably supported with respect to the gear casing, and is movable with respect to the relay rod in the axial direction thereof; and
gear members for transmitting rotation of the input shaft to the spline nut.

3. The steering device according to claim 2, wherein the gear members constitutes a pair of bevel gears respectively fixed to the input shaft and the spline nut, the bevel gears urged in a direction of meshing with each other.

4. The steering device according to claim 1, further comprising:
a retention mechanism provided to the gear casing, for restoring the relay rod to a predetermined axial position; and
a restriction member provided to the retention mechanism and engaged with the relay rod in an axial direction thereof,
the restriction member being urged by a pair of elastic members from both sides in the axial direction thereof so as to retain the relay rod correspondingly to a straightforward advance position of the steerable wheels.

5. The steering device according to claim 4, wherein an engagement state of the restriction member and the relay rod is cancelled when the relay rod moves from the straightforward advance position of the steering wheels by at least a predetermined distance.

6. The steering device according to claim 5, wherein the retention mechanism comprises:
multiple balls arranged along a circumferential direction of the relay rod and serving as the restriction member;
an annular engagement groove formed along the peripheral direction of the relay rod so as to engage the balls therewith;
a fixation outer cylinder fixed to the gear casing, for sandwiching the balls between the fixation outer cylinder and the relay rod, and for canceling an engagement state of the relay rod and the balls in accordance with an axial movement amount of the relay rod;
a pair of coil springs for urging the balls from both sides thereof in the axial direction; and
a pair of bearing rings interposed between the coil springs and the balls.
